(19) United States
(12) Patent Application Publication
(10) Pub. No.: US 2003/0236666 A1
(43) Pub. Date: Dec. 25, 2003

(54) System for accessing a database using human speech

(75) Inventor: George Henry Hepker VI, Sunnyvale, CA (US)

Correspondence Address: BURNS DOANE SWECKER & MATHIS L L P, POST OFFICE BOX 1404, ALEXANDRIA, VA, 22313-1404, US

(73) Assignee: Talk-Back Incorporated, Belmont, CA

(21) Appl. No.: 10/394,999

(22) Filed: Mar. 24, 2003

Related U.S. Application Data
(60) Provisional application No. 60/368,984, filed on Apr. 2, 2002.

(51) Int. Cl. G10L 13/00

(52) U.S. Cl. 704/260

(57) ABSTRACT

A voice access system for a database having a management application which interacts with the database for accessing and/or modifying information contained in the database is provided. The voice access system including a voice portal for exchanging voice information with a human user, and an intermediary application in communication with the voice portal and a management application, the intermediary application creating one or more voice format documents populated by information from the database in response to queries from a human user.

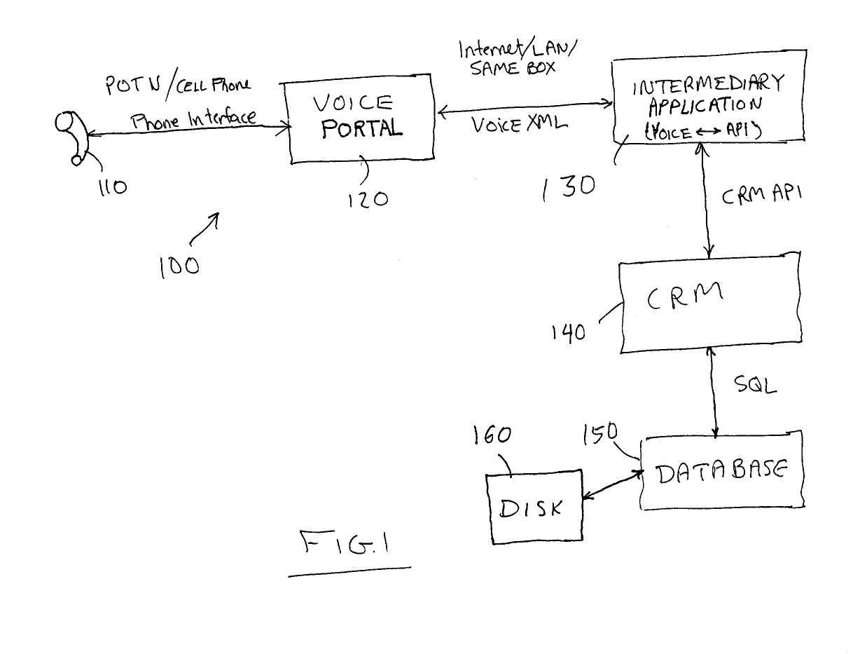

### CROSS-REFERENCE TO RELATED APPLICATIONS

This application claims the benefit under 35 U.S.C. §119 of U.S. Provisional Patent Application No. 60/368,984, filed Apr. 2, 2002, the contents of which are incorporated herein in their entirety.

### BACKGROUND OF THE INVENTION

1. Field of the Invention

The invention relates to a system for providing automated voice access to a database.

2. Description of Related Art

Traditionally, access to a database, for example one in which information about cable service subscribers is stored, must be gained through a human operator who manually enters appropriate queries into a computer terminal. The queries are forwarded to managing software such as a Customer Relations Management (CRM) application which in turn queries the database and obtains the appropriate information therefrom.

A field worker whose access is limited and who requires information from a database—for example a technician for a cable television service provider who is onsite and who must determine the exact nature of the connection and service to which a customer is entitled—such a field worker would have to telephone the human operator, who in turn would manually query the database as described above, receive the appropriate response, then, over the telephone, convey that response back to the field worker. This process is cumbersome and time consuming, as there may be a limited number of human operators, and a queue may need to be established, introducing delay and added expense into the service process.

Accordingly, there is a long-felt need to automate the database access process, in order to reduce costs and delays associated with such access particulary from remote locations or onsite service operation.

### BRIEF SUMMARY OF THE INVENTION

In accordance with the invention, a voice access system for a database having a management application which interacts with the database for accessing and/or modifying information contained in the database is provided. The voice access system includes a voice portal for exchanging voice information with a human user, and an intermediary application in communication with the voice portal and the management application, the intermediary application creating one or more voice format documents populated by information from the database in response to queries from the human user.

Further in accordance with the invention, a method for providing voice access to a database having a management application which interacts with the database for accessing and/or modifying information contained in the database is disclosed. The method includes accessing the management application of the database, retrieving information from the database through the management application, generating voice format documents containing the retrieved information, and converting information in the voice format documents to human-intelligible speech.

### BRIEF DESCRIPTION OF THE SEVERAL VIEWS OF THE DRAWING(S)

Many advantages of the present invention will be apparent to those skilled in the art with a reading of this specification in conjunction with the attached drawings, wherein like reference numerals are applied to like elements.

The drawing FIGURE is a schematic diagram illustrating the interactions of various components in accordance with the invention.

### DETAILED DESCRIPTION OF THE INVENTION

The system of the invention allows the user to use a telephone to access, create and/or modify information in a database. With respect to an exemplary embodiment of a Customer Relations Management (CRM) application, the system allows a user to read and/or modify information in a CRM system. Information is accessed from a CRM system using the CRM system's dedicated application programming interface (referred to as API) and reformatting the data so it can be accessed using a telephone. This accessing method is implemented using the CRM software's normal workflow model and allows the workflow to know that the interface used to update the ticket was a voice interface.

The drawing FIGURE schematically shows the system 100 of the invention, wherein a telephone 110, such as a cellular telephone or a conventional landline telephone or other voice communication device, is in communication with voice portal 120, which is in turn in communication with intermediary application 130, for example via the Internet, a local or wide area network, or, conceivably, through a local bus if the two systems are in the same “box.” Intermediary application 130 communicates with CRM 140, which, through the CRM API (application programming interface), has access to database 150, for example via SQL-type queries. Data in CRM system 140 is stored as text, numerical data, or binary data. Disks 160 provide information storage capacity for the database.

Intermediary application 130 communicates with the CRM software, creating human-to-computer dialog formatted into voiceXML. Intermediary application 130 operates as a bridge between the CRM system and voice portal 120, running voice applications constructed with software enabling a user to read, create, modify and delete entries from the CRM system. The intermediary application 130 has a stored format for a voice application. A voice application created by the intermediary application consists of a combination of reading, creating, modifying and deleting entries from the CRM system. Raw information from the CRM system is analyzed and formatted according to a voice application. The intermediary application 130 translates the raw data into a vocal format more understandable for human user. This dialog is formatted into a voiceXML format and is sent to the voice portal 120. The voice portal 120 interprets the voiceXML and may send additional requests to the intermediary software 130 for more voiceXML information.

The voice portal 120 is a combination of hardware and software that allows interaction with telephone or other communication device 110. It translates voiceXML information into vocal dialog which can be received and understood by a human, for example using Text-To-Speech (TTS) expedients, and translates voice information from a human to voiceXML data which is forwarded to the intermediary application 130 for processing.

When a user, such as a field worker, calls a telephone number dedicated to use in accordance with the invention, the voiceXML software implemented in voice portal 120 will answer the telephone call, possibly applying a user verification method, and send a query to intermediary application 130 including the caller's telephone number. The intermediary application 130 sends a query to the CRM system 140 requesting data and fields information that are defined in the CRM system. The intermediary application 130 will format the data and field information and create one or more voiceXML documents. These VoiceXML documents will drive spoken conversation from a CRM server to the user, spoken conversation from the user to the server, and telephone number keystrokes the user enters into the telephone.

The user initiates a dialog with the system using the telephone 110. Voice portal 120, sends a request to the intermediary application 130 for a voiceXML form with the identity of the user. The intermediary application 130 requests the CRM software for the format of the voice interface and data presented in the interface. Alternatively, this format can be stored in the database 150, for example as separate tables, or in the software 130 itself, or anywhere in layers in the third, fourth or fifth layers discussed below. The CRM software has a special application created by the intermediary application 130 that stores the format of the voice interface. The CRM 140 returns the format and content of the voice interface. The CRM software populates a voiceXML document with the relevant queried information, and returns it to the voice portal 120. The voice portal 120 uses text-to-speech (TTS) and speech recognition to communicate with the user based on the voiceXML document.

The invention can be organized into six layers of interaction between the user and the system. These are:

| | |
|---|---|
| Layer 1: | Telephone |
| Layer 2: | Voice portal/VoiceXML |
| Layer 3: | Intermediary application |
| Layer 4: | CRM software |
| Layer 5: | Database |
| Layer 6: | Disk |

Each layer preferably communicates only with the layer above and the layer below. VoiceXML will provide the voice driven interface. Acronyms and technical terms that cannot correctly be converted to clear sounding speech will be translated to clear sounding speech using phonetic substitution. A selected database of words will be replaced with phonetic string equivalents by the intermediary software. The creation of voice menus, the workflow, and the content of voice menus will be designed using the CRM software. The intermediary software will read, design, and lay out information stored in the CRM software and create all required voiceXML code.

The above are exemplary modes of carrying out the invention and are not intended to be limiting. It will be apparent to those of ordinary skill in the art that modifications thereto can be made without departure from the spirit and scope of the invention as set forth in the following claims.

1. A voice access system for a database having a management application which interacts with the database for accessing and/or modifying information contained in the database, the voice access system comprising:
a voice portal for exchanging voice information with a human user; and
an intermediary application in communication with the voice portal and the management application, the intermediary application creating one or more voice format documents populated by information from the database in response to queries from the human user.

2. The voice access system of claim 1, wherein the voice format is voiceXML.

3. The voice access system of claim 1, wherein the intermediary application communicates with an applications programming interface (API) of the managing application.

4. The voice access system of claim 1, wherein the voice information includes tones generated by a telephone.

5. The voice access system of claim 1, wherein the voice portal includes a text-to-speech (TTS) translator for converting information contained in the one or more voice format documents to human-intelligible sound information.

6. The voice access system of claim 1, wherein the voice portal includes voice recognition software for converting human speech into electronic format.

7. The voice access system of claim 1, wherein communication between the voice portal and intermediary application, and/or communication between the intermediary application and the management application, is effected over a network.

8. A method for providing voice access to a database having a management application which interacts with the database for accessing and/or modifying information contained in the database, the method comprising:
accessing the management application of the database;
retrieving information from the database through the management application;
generating voice format documents containing the retrieved information; and
converting information in the voice format documents to human-intelligible speech.

9. The method of claim 8, wherein the voice format is voiceXML.

10. The method of claim 8, wherein accessing is performed through an applications programming interface (API) of the managing application.

11. The method of claim 8, wherein accessing is effected in response to tones generated by a telephone.

12. The method of claim 8, further including:
receiving voice information from a human user;
performing voice recognition on the received voice information;
generating queries based on results of the voice recognition; and
accessing the management application based on the generated queries.
